(19) United States
(12) Patent Application Publication
(10) Pub. No.: US 2025/0004198 A1
(43) Pub. Date: Jan. 2, 2025

(54) OPTICAL COUPLING DEVICE AND RESPECTIVE METHOD FOR TUNING

(71) Applicant: PHOTONPATH S.R.L, Milano (IT)

(72) Inventors: Alessandro PERINO, MILANO (IT); Elena DAMIANI, MILANO (IT); Douglas OLIVEIRA MORAIS DE AGUIAR, MILANO (IT); Emanuele GUGLIELMI, MILANO (IT)

(21) Appl. No.: 18/696,566

(22) PCT Filed: Sep. 26, 2022
(86) PCT No.: PCT/IT2022/050257

§ 371 Date: Mar. 28, 2024

(30) Foreign Application Priority Data
Sep. 30, 2021 (IT) 102021000025160

(51) Int. Cl. G02B 6/12; G02F 1/01; G02F 1/025

(52) U.S. Cl. CPC G02B 6/12033; G02B 6/12016; G02F 1/0147; G02F 1/025; G02B 2006/12097; G02B 2006/12135; G02B 2006/12145; G02B 2006/12147; G02B 2006/1215

(57) ABSTRACT

Optical coupling device (99) and method for tuning the device, the device comprising a pair of optical waveguides (1, 2) mutually optically coupled respectively at a first (3) and a second optical coupling tract (7) having main development along a longitudinal direction (100), and a first electrode (8) and a second electrode (9) electrically connected to the first optical waveguide (1) at longitudinally opposite sides of the first optical coupling tract (3), the method comprising applying an electric voltage difference between the first (8) and second electrode (9) to provide a passage of electric current into the first optical coupling tract (3), introducing an input optical signal, adjusting a value of the electric voltage difference to vary a ratio between optical powers of a pair of output optical signals.

### TECHNICAL FIELD OF THE INVENTION

The present invention relates to an optical coupling device and a method for tuning said device.

### STATE OF THE ART

The present invention is placed in the field of photonics, that is the set of the technologies and of the methods for the generation, transmission, processing and reception of optical signal.

The term “optical” refers to an electromagnetic radiation that falls within a broadened neighbourhood of the visible optical band, and does not necessarily falling strictly within the visible optical band (i.e. indicatively 400-700 nm), for example this broadened neighbourhood of the visible optical band typically comprises the near infrared (for example wavelength between about 700 nm to about 2 μm).

In the field of photonics, optical coupling devices are known, in which an optical signal entering an input port is divided into two distinct optical signals, each exiting from a respective output port.

In one embodiment, an optical coupling device may comprise a pair of optical waveguides mutually optically coupled at a coupling region.

Tunable optical coupling devices are also known, in which a ratio between the optical powers of the two output optical signals (splitting ratio) can be dynamically varied, at a given wavelength (up to including the case of a ratio that goes from 0-100 to 100-0), and/or the wavelength at which a given ratio between the optical powers is obtained can be varied.

By the term “doping” it is meant, in the field of the semiconductors, the addition to the pure semiconductor (also called “intrinsic”) of variable percentages of atoms of elements different with respect to the pure semiconductor (e.g. silicon, silicon carbide), in order to modify the physical properties of the material constituting the pure semiconductor. Typically, the doping improves the electric conductivity of the pure semiconductor. The types of doping are commonly two and are defined respectively as “n” type and “p” type. The types of doping and the operational properties that such types of doping confer to the pure semiconductor are known per se and will not be further described.

The document WO2020089495A1 discloses a tunable optical coupling device.

The document “Tunable silicon photonics directional coupler driven by a transverse temperature gradient”, Orlandi et al., Mar. 15, 2013/Vol. 38, No. 6/OPTICS LETTERS, discloses an optical coupling device that can be tuned by heating of a heating element (e.g. electric resistance) placed in proximity to one of the two waveguides to establish a thermal gradient between the two waveguides. It is in fact known that the temperature variation of a waveguide determines a variation of the optical properties of the material of which it is composed, allowing the adjustment of the ratio between the optical powers of the output signals (e.g. by variation of the refractive index of the heated waveguide).

### SUMMARY OF THE INVENTION

The Applicant has realized that the tuning of an optical coupling device by means of a heating element arranged in proximity to one of the waveguides (due to thermo-optical effect), as for example described in the aforementioned documents, is inefficient under many respects.

In fact, in order to heat the waveguide, it is first necessary to heat the heating element (e.g. by passage of current) and wait for the heat to transfer from the latter to the waveguide by thermal conduction through the layer that typically incorporates the waveguides (and sometimes even the heating element itself). It therefore follows a time delay between the instant in which the thermal power is generated in the heating element and the consequent temperature increase of the waveguide, which can make tuning unsuitable for the rapid times typical of the optical circuits.

Furthermore, to obtain a desired temperature increase of the waveguide, given the intrinsic thermal resistance of the materials typically used to make the device, such as for example the aforementioned layer (typically made of silicon oxide), it is necessary to significantly increase the temperature of the heating element, with consequent thermal dissipation and high energy consumption.

In addition, although the heating element is typically arranged in proximity to the waveguide to be heated, the thermal power generated is also partially transferred to the other waveguide (‘thermal cross-talk’), resulting in an increase in the respective temperature and therefore an overall decrease in the thermal gradient between the two waveguides, limiting the range of values in which the aforementioned ratio between the optical powers can be varied and/or increasing the necessary temperatures (and therefore consumption).

The Applicant has therefore faced the problem of realizing an optical coupling device capable of being tuned, in particular by the thermo-optical effect, in an efficient, simple, rapid and cheap way.

According to the applicant, the above problem is solved by an optical coupling device and by a method for tuning said device according to the attached claims and/or having one or more of the following features.

According to an aspect the invention relates to an optical coupling device.

The device comprises:
a first optical waveguide made of semiconductor having a first input and a first output;
a second optical waveguide having a second input and a second output;
wherein said first and second optical waveguide are mutually optically coupled at respectively a first and a second optical coupling tract respectively interposed between said first input and first output and between said second input and second output,
wherein said first and second optical coupling tract have main development along a longitudinal direction;
a first electrode and a second electrode electrically connected to said first optical waveguide at longitudinally opposite sides of said first optical coupling tract.

According to an aspect, the invention relates to a method for tuning an optical coupling device. The method comprises:
providing said optical coupling device according to the present invention;
applying an electric voltage difference between said first and second electrode to provide a passage of electric current into said first optical coupling tract;
introducing an optical signal as input to said first input;
adjusting a value of said electric voltage difference to vary a ratio between optical powers of a first optical signal exiting from said first output and a second optical signal exiting from said second output.

The Applicant has realized that, in order to tune an optical coupling device by heating, it is possible to heat one of the two optical waveguides thanks to direct injection of electric current into the optical waveguide itself (e.g. by exploiting the Joule effect), without having to provide any heating element distinct from the optical waveguide.

In this way the tuning by thermo-optical effect is achieved by heating of an optical waveguide in an efficient and rapid way, simplifying at the same time the structure of the device and limiting the heating of the other optical waveguide, thus obtaining a wide tuning range and/or a limited power consumption.

The Applicant believes that the injection of electric current into the optical waveguide does not interfere with the optical signal transmitted along the optical waveguide during the operation of the device.

The present invention in one or more of the above aspects may exhibit one or more of the following preferred features.

Preferably said second optical waveguide is made of semiconductor. In this way the waveguides can be made with the same technology, to the advantage of the simplicity of the device.

Preferably said first and second optical waveguide each comprise a respective main development line (e.g. a line of path of the optical signal).

Preferably said first optical waveguide is doped (at least in a tract from the first to the second electrode), preferably with a single type of doping. In this way the passage of electric current is improved.

Preferably a density of doping of the first optical waveguide at a contact area with respectively said first and second electrode is greater than a density of doping of a remaining part of the first optical waveguide. In this way, a reservoir for the charge carriers is created and/or the electric contact between electrodes and first optical waveguide is improved.

Preferably said density of doping at the contact area is greater than or equal to 10¹⁵ atoms/cm³, more preferably greater than or equal to 10¹⁷ atoms/cm³, and/or less than or equal to 10²¹ atoms/cm³, more preferably less than or equal to 10²⁰ atoms/cm³.

Preferably said density of doping of the remaining part of the first optical waveguide is greater than or equal to 10¹⁴ atoms/cm³, more preferably greater than or equal to 10¹⁶ atoms/cm³, and/or less than or equal to 10¹⁸ atoms/cm³, more preferably less than or equal to 10¹⁷ atoms/cm³. Such densities of doping are particularly suitable for the transmission of electric currents while limiting the manufacturing costs and/or potential disturbances to the propagation of the optical signal.

Preferably said first optical waveguide (only) at said first and second electrode is a rib waveguide. Preferably said rib waveguide has section, on a plane (substantially) perpendicular to said main development line, which comprises a central portion and a first and a second lateral portion arranged at opposite sides of, and in continuity with, said central portion and having lower height with respect to the central portion.

Preferably each of said first and second electrode is in (direct) electric contact with at least one of said first and second lateral portion. In this way the lateral portions provide sufficient space to arrange the electrodes while limiting the interference with the optical signal.

Preferably said first and second electrode are arranged externally to said first optical coupling tract. In this way the available space is used to place the electrodes.

Preferably each of said first and second electrode is in (direct) electric contact with both said first and second lateral portion. In this way the electric contact is improved.

Preferably said first and second optical waveguide are mutually electrically insulated. In this way the electric current is prevented from flowing into the second optical waveguide, heating it.

Preferably said first optical waveguide (more preferably each optical waveguide) is a channel waveguide at (entirely) said first (and respectively second) optical coupling tract. In this way the aforesaid electric insulation is achieved in constructively simple way.

Preferably said first and second lateral portion of said section of the first optical waveguide taper towards the central portion moving along said main development line from said contact area towards said first optical coupling tract. In this way the transition zone from “rib waveguide” to “channel waveguide” is effectively realized.

Preferably each electrode has section that tapers moving towards said first optical waveguide. In this way the electric contact is favoured.

Preferably said devices comprises a longitudinal plane of symmetry. In this way the device is rational.

Preferably said device comprises a transverse plane of symmetry (substantially) perpendicular to said longitudinal plane of symmetry. In this way the functioning of the device is improved.

Preferably said device comprises a layer of electrically insulating material (e.g. silicon oxide). Preferably said layer substantially entirely surrounds (e.g. with exception of the electrode areas) said first and second optical waveguide. In this way the device is robust and an electric separation between the optical waveguides is achieved.

### BRIEF DESCRIPTION OF THE DRAWINGS

FIG. 1 schematically shows a top view of the optical coupling device according to the present invention;

FIG. 2 schematically shows a section along the plane AA of FIG. 1;

FIG. 3 schematically shows a section along the plane BB of FIG. 1;

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures (not to scale). In the figures, the number 99 indicates an optical coupling device. Exemplarily the device 99 comprises a first optical waveguide 1 made of semiconductor (e.g. silicon, silicon carbide, etc.) having a first input 10 and a first output 11, and a second optical waveguide 2 made of semiconductor having a second input 20 and a second output 21.

Exemplarily the first 1 and the second optical waveguide 2 are mutually optically coupled at respectively a first 3 and a second optical coupling tract 7 respectively interposed between the first input and the first output and between the second input and the second output.

Exemplarily the first 3 and the second optical coupling tract 7 have main development along a longitudinal direction 100.

Exemplarily the device 99 comprises a first electrode 8 and a second electrode 9 electrically connected to the first optical waveguide 1 at longitudinally opposite sides of, and externally to, the first optical coupling tract 3.

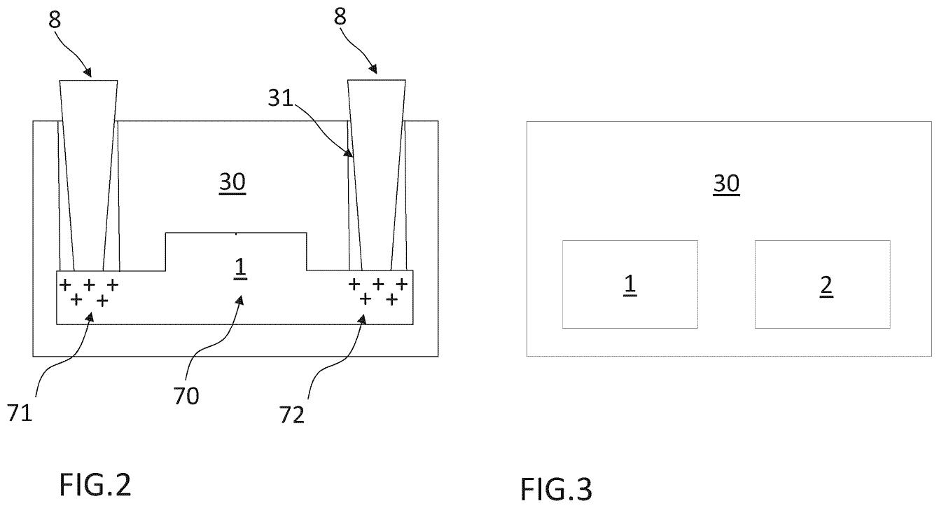

Exemplarily the first optical waveguide 1 is doped with only a single type of doping (i.e. “n” or “p”) along its entirety, wherein a density of doping at a contact area with respectively the first 8 and the second electrode 9 (schematically indicated by the +signs in FIG. 2) is greater than a density of doping of the remaining part. Exemplarily the density of doping at the contact areas with the electrodes is equal to about 10¹⁹ atoms/cm³, and the density of doping of the remaining part is about 10¹⁶ atoms/cm³.

Exemplarily the first optical waveguide 1 only at the first 8 and second electrode 9 is a rib waveguide having a section, on a plane perpendicular to a main development line of the first optical waveguide (e.g. the plane AA), which comprises a central portion 70 and a first 71 and a second lateral portion 72 arranged at opposite sides of, and in continuity with, the central portion 70 and having a lower height with respect to the central portion 70 (i.e. the section has an inverted T profile).

Exemplarily each first 8 and second electrode 9 is arranged in direct electric contact with both the first 71 and the second lateral portion 72.

Exemplarily the first 1 and the second optical waveguide 2 are mutually electrically insulated, and to this end they both are a channel waveguide respectively at entirely the first 3 and the second optical coupling tract 7.

Exemplarily the lateral portions 71, 72 of the section of the first optical waveguide taper towards the central portion 70 moving along the main development line from the contact area with the electrode towards the first optical coupling tract 3. Advantageously, at the first optical coupling tract 3 the first optical waveguide 1 has the same cross-sectional shape (FIG. 3) as the central portion 70.

Exemplarily each electrode is made of metallic material with section that tapers moving towards the first optical waveguide 1.

Exemplarily the device 99 comprises a layer 30 of electrically insulating material (e.g. silicon oxide) which substantially entirely surrounds (with exception of the electrode areas) the first and second optical waveguide. Exemplarily the layer 30 is equipped with openings 31 at the electrodes to allow electric contact between the electrode and the optical waveguide.

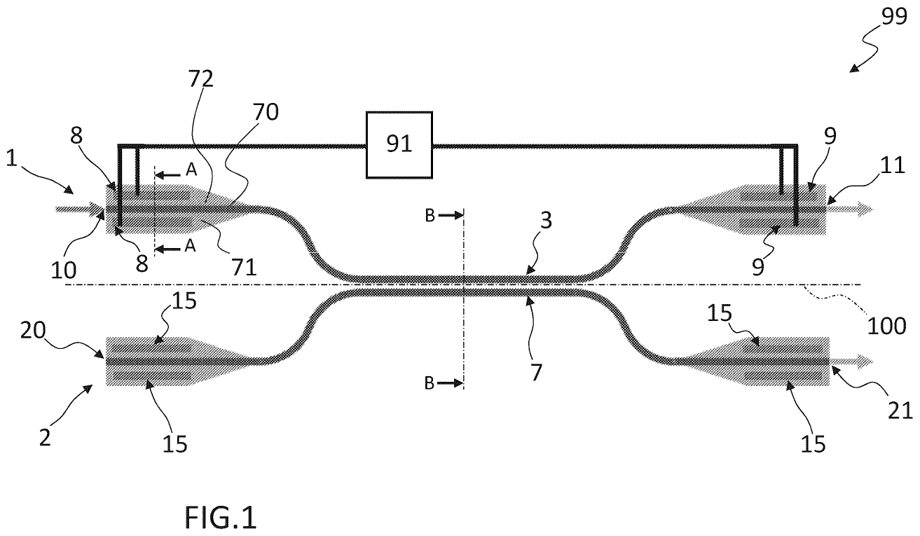

Exemplarily the device comprises a longitudinal plane of symmetry (which crosses the plane of the FIGS. 1 and 4 along the longitudinal direction 100), and a transverse plane of symmetry perpendicular to the longitudinal plane of symmetry (in FIG. 1 coinciding with the section plane BB).

Exemplarily the second optical waveguide has all the features of the first optical waveguide (e.g. it mirrors the first optical waveguide with respect to the longitudinal plane of symmetry, FIG. 1) and the device comprises a pair of electrodes 15 electrically connected to the second optical waveguide at longitudinally opposite sides of the second optical coupling tract 7. In this way it is possible to tune the device by heating the second optical waveguide by injecting electric current directly into the second optical waveguide (alternatively to heating the first optical waveguide). In this way the device is highly versatile.

In use, the device 99 exemplarily allows to divide an optical signal entering the first input 10, in a pair of optical signals exiting respectively from the first output 11 and from the second output 21 (in the figures the optical signals are represented by oriented arrows).

Optionally (not shown), an optical signal can be fed into the second input and divided between the outputs.

Exemplarily, the device 99 can be tuned to dynamically vary the ratio between the optical powers of the signals exiting respectively from the first output 11 and from the second output 21.

Exemplarily for tuning the device 99 it is provided applying an electric voltage difference between the first 8 and the second electrode 9 to provide a passage of electric current (not shown) into the first optical coupling tract 3 (exemplarily along substantially all the first optical waveguide), and adjusting a value of the electric voltage difference to vary the aforementioned ratio between the optical powers. The passage of electric current exemplarily heats the first optical waveguide 1 by means of Joule effect.

Exemplarily in FIG. 1 it is schematically shown a voltage generator 91 electrically connected to the first 8 and the second electrode 9 for applying the aforementioned electric voltage difference.

1. An optical coupling device comprising:
a first optical waveguide made of semiconductor having a first input and a first output;
a second optical waveguide having a second input and a second output;
wherein said first and second optical waveguide are mutually optically coupled at respectively a first and a second optical coupling tract respectively interposed between said first input and first output and between said second input and second output,
wherein said first and second optical coupling tract have main development along a longitudinal direction;
a first electrode and a second electrode electrically connected to said first optical waveguide at longitudinally opposite sides of said first optical coupling tract.

2. The device according to claim 1, wherein said first optical waveguide is doped at least in a tract from the first to the second electrode, with a single type of doping, wherein a density of doping of the first optical waveguide at a contact area with respectively said first and second electrode is greater than a density of doping of a remaining part of the first optical waveguide, wherein said density of doping at the contact area is greater than or equal to 10¹⁵ atoms/cm³, and less than or equal to 10²¹ atoms/cm³, and wherein said density of doping of the remaining part of the first optical waveguide is greater than or equal to 10¹⁴ atoms/cm³, and less than or equal to 10¹⁸ atoms/cm³.

3. The device according to claim 1, wherein said first optical waveguide at said first and second electrode is a rib waveguide having section, on a plane substantially perpendicular to a main development line of the first optical waveguide, which comprises a central portion and a first and a second lateral portion arranged at opposite sides of, and in continuity with, said central portion and having lower height with respect to the central portion, wherein each of said first and second electrode is in electric contact with at least one of said first and second lateral portion.

4. The device according to claim 3, wherein each of said first and second electrode is in electric contact with both said first and second lateral portion.

5. The device according to claim 1, wherein said first and second electrode are arranged externally to said first optical coupling tract, wherein said first and second optical waveguide are mutually electrically insulated, and wherein said first optical waveguide is a channel waveguide at said first optical coupling tract.

6. The device according to claim 5, wherein said second optical waveguide is a channel waveguide at said second optical coupling tract.

7. The device according to claim 3, wherein said first and second lateral portion of said section of the first optical waveguide taper towards the central portion moving along said main development line from a respective contact area with a respective electrode towards said first optical coupling tract.

8. The device according to claim 1, wherein each electrode has section that tapers moving towards said first optical waveguide, and wherein said device comprises a layer of electrically insulating material which substantially entirely surrounds said first and second optical waveguide.

9. The device according to claim 1, comprising a longitudinal plane of symmetry and a transverse plane of symmetry substantially perpendicular to said longitudinal plane of symmetry, and wherein said second optical waveguide is made of semiconductor.

10. A method for tuning an optical coupling device, the method comprising:
providing said optical coupling device according to claim 1;
applying an electric voltage difference between said first and second electrode to provide a passage of electric current into said first optical coupling tract;
introducing an optical signal as input to said first input;
adjusting a value of said electric voltage difference to vary a ratio between optical powers of a first optical signal exiting from said first output and a second optical signal exiting from said second output.
